(19) United States
(12) Patent Application Publication
(10) Pub. No.: US 2013/0141739 A1
(43) Pub. Date: Jun. 6, 2013

(54) PRINTER DRIVER CACHING ARCHITECTURE

(71) Applicant: Alan Jay Swire, Pittsford, NY (US)

(72) Inventor: Alan Jay Swire, Pittsford, NY (US)

(21) Appl. No.: 13/312,658

(22) Filed: Dec. 6, 2011

(51) Int. Cl. G06K 15/02

(52) U.S. Cl. 358/1.4; 358/1.15

(57) ABSTRACT

A printing system with a printer having a pair of printheads for printing on opposite sides of a receiver media. A host computer connected to the printer controls a page printing sequence in the printer and has a renderer for generating first page data to be printed. A language monitor determines that second page data is to be printed before the first page data, and so it delays sending a print command to the printer until the second page data is rendered. Then the language monitor sends a print command to the printer with the second page data before sending the first page data.

### CROSS REFERENCE TO RELATED APPLICATIONS

U.S. patent application Ser. No. 13/______, entitled “Printer Driver Caching Method” filed concurrently herewith is assigned to the same assignee hereof, Eastman Kodak Company of Rochester, N.Y., and contains subject matter related, in certain respect, to the subject matter of the present application. The above-identified patent application is incorporated herein by reference in its entirety.

Reference is made to commonly assigned, co-pending U.S. patent applications: Ser. No. 13/300,183 filed Nov. 18, 2011, entitled “System For Maintaining Proper Page Sequence While Reducing Printer Artifacts”; Ser. No. 13/300,251 filed Nov. 18, 2011, entitled “Printing Method For Maintaining Proper Page Sequence While Reducing Printer Artifacts”; Ser. No. 13/300,282 filed Nov. 18, 2011, entitled “Method For Maintaining Proper Page Sequence While Reducing Printer Artifacts”; Ser. No. 13/300,313 filed Nov. 18, 2011, entitled “Printing System For Maintaining Proper Page Sequence While Reducing Printer Artifacts”; the disclosures of which are incorporated herein by reference in their entireties.

### FIELD OF THE INVENTION

The present invention is directed to duplex printing. In particular, the present invention is directed to methods and apparatuses for selectably controlling the order in which surfaces (the front and back sides of a duplex sheet) are sent to a multi-printhead duplex printer for printing thereby.

### BACKGROUND OF THE INVENTION

To overcome image quality issues in certain thermal duplex printers, the surface order delivery needs to vary in an irregular fashion, e.g., side A, side B, side B, side A. This irregular delivery sequence reduces the amount of contact between printed sheet surfaces and the drive roller. The drive roller typically comprises an aggressive texture for better feed control, however, it also compromises printable media surfaces and can deteriorate image quality. This method is inconsistent with the surface delivery mechanism from the Microsoft Windows driver, which always delivers rendered surfaces in a repeated and alternating “side A, side B” order (but which can start with either side). The central issue which needs to be resolved is how surfaces (the front and back sides of a duplex sheet) can be selectively delivered to a duplex printer that is capable of initially printing either side of a media sheet before printing the other side of the sheet. Certain software does not face this issue because both the front and back surfaces of a duplex sheet are individually available for selection prior to the delivery of the sheet print commands to the printer. Thus, there is a need in the art for a new printing architecture that implements a novel caching mechanism within the print driver. These changes are required to achieve the irregular surface delivery pattern that is required to obviate image quality issues.

### SUMMARY OF THE INVENTION

A preferred embodiment of the present invention comprises a printing system with a bidirectional printer having a pair of printheads for printing on opposite sides of a receiver media. A host computer connected to the printer controls a page printing sequence in the printer and has a renderer for generating first page surface data to be printed on one side of a receiver media in the printer. A language monitor determines that second page surface data is to be printed on the receiver media before the first page surface data, and so it delays sending a print command to the printer until the second page surface data is rendered. Then the language monitor sends a print command to the printer with the second page surface data before sending the first page surface data. The language monitor comprises programming for receiving information identifying a position of the receiver media in the printer and, in response to the information, determines that the second page surface data is to be printed on the receiver media before the first page surface data. The printing system comprises storage for temporarily storing the first page surface data while the second page surface data is rendered. These pages comprise a portion of a print job and the print job comprises a plurality of even numbered pages and a plurality of odd numbered pages. The language monitor is configured to print pairs of the even numbered pages consecutively during the print job and as well as pairs of the odd numbered pages. The print job is often a duplex print job. All of the even numbered pages are printed on one of the printheads and all of the odd numbered pages are printed on another one of the printheads.

Another preferred embodiment of the present invention comprises a printing system with a renderer configured for generating print image data for a first logical page of a duplex print job. A language monitor is configured for receiving information from a connected printer identifying a position of a receiver media in the printer with respect to one of two printheads in the printer. In response, it determines that a second logical page of the print job is to be printed next in the printer before printing the first logical page. It temporarily stores the first logical page of the print job while print image data for the second logical page is being generated. The language monitor also sends the second logical page of the print job to the printer before sending the first logical page. The language monitor queries the printer to identify the position of the receiver media. The first and second logical pages of the print job comprise a portion of the print job, and the print job comprises even numbered pages and odd numbered pages. Pairs of the even numbered pages are printed consecutively as well as the odd numbered pages. Each of the odd numbered pages is printed by only one of the printheads on an opposite side of the receiver media from an even numbered page. The system can temporarily store the first logical page of the print job on a hard disk of the system.

Another preferred embodiment of the present invention comprises a printing system having a printer and a host computer connected to the printer. The host sends print commands and first page data to the printer. A renderer in the host generates the first page data and temporarily stores it in system storage. A language monitor is configured to selectively either send the print commands and the first page data to the printer or to retain the first page data in the system storage until the renderer completes generating second page data. A receiver media is positioned at either one of two printheads in the printer, wherein the host receives printer status data from the printer indicating the position of the receiver media. Based on this position, the language monitor is further configured to selectively either send the print commands and the first page data to the printer or to retain the first page data in system storage. The language monitor sends the second page data to the printer for printing on one side of the receiver media followed by sending the first page data to the printer for printing on an opposite side of the receiver media. The first page data is printed using only one of the printheads and the second page data is printed using only another one of the printheads.

Another preferred embodiment of the present invention comprises a printing system having a renderer for generating image data for a logical first page of a print job and for generating a logical second page of the print job. Attached storage is used to store the image data for the logical first page of the print job and for the logical second page of the print job. The status data from the printer indicates a position of receiver media in the printer with respect to one of two printheads. A language monitor starts the print job in duplex format and is configured to send the logical second page of the print job before sending the logical first page of the print job. The image data for the logical first page and the logical second page are each accessible by the language monitor for being sent to the printer. The status data indicates which one of the two printheads is capable of printing on the receiver media without retracting the receiver media. The system comprises means for requesting the status data from the printer.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. For example, the summary descriptions above are not meant to describe individual separate embodiments whose elements are not interchangeable. In fact, many of the elements described as related to a particular embodiment can be used together with, and possibly interchanged with, elements of other described embodiments. Many changes and modifications may be made within the scope of the present invention without departing from the spirit thereof, and the invention includes all such modifications. The figures below are intended to be drawn neither to any precise scale with respect to relative size, angular relationship, or relative position nor to any combinational relationship with respect to interchangeability, substitution, or representation of an actual implementation.

### BRIEF DESCRIPTION OF THE DRAWINGS

FIG. 1 illustrates a preferred embodiment of a print driver architecture for selective delivery of print surfaces to a printer.

FIG. 2 illustrates a Windows driver that can be modified to operate in accordance with a preferred embodiment the present invention.

FIGS. 3A-B illustrate print command structures.

FIG. 4 illustrates a user interface plug-in design.

FIG. 5 illustrates a printing system.

### DETAILED DESCRIPTION OF THE INVENTION

The invention has been described in detail with particular reference to certain preferred embodiments thereof, but it will be understood that variations and modifications can be effected within the spirit and scope of the invention.

### Printer Driver Architecture

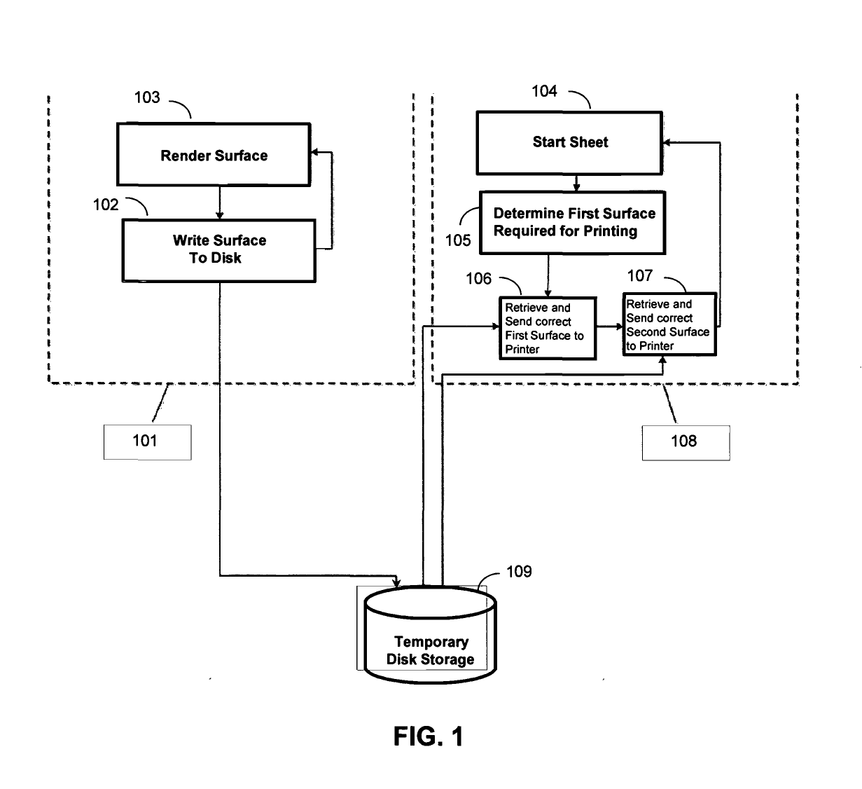

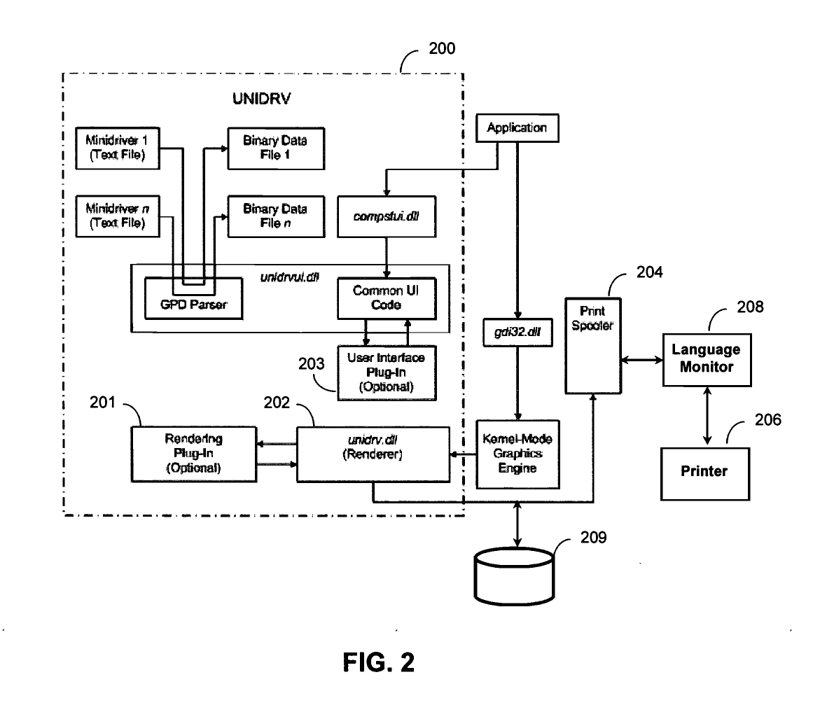

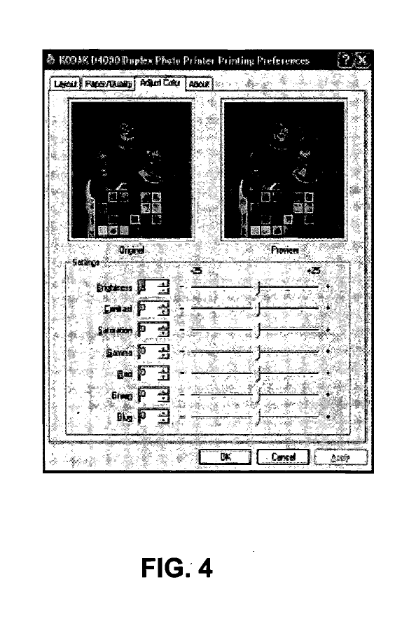

With reference to FIGS. 1-2, many Windows printer drivers are based on the Microsoft Universal Printer Driver architecture (Unidrv) 200. The present implementation of these printer drivers includes a Rendering Plug-In 101, 201 which provides unique functionality such as, for example, color adjustment, scaling, and adding white borders to bordered prints. A User Interface Plug-In 203 provides the user the ability to select specific unique features such as launching a calibration utility, or a slider bar for selecting the color adjustments, such as illustrated in FIG. 4, for example.

### Language Monitor Architecture

In addition to the employing the Microsoft Universal Printer Driver architecture in modified printer driver embodiments described herein, a Microsoft Language Monitor 108, 208 has been implemented for each printer and is installed at the time of Printer Driver installation. The Language Monitor is responsible for (in most cases) building and sending USB command requests to, and for handling USB command responses from, the printer. Microsoft describes, in part, Language Monitors as follows

“Language Monitors are user-mode DLLs that serve two purposes:
They provide a full duplex communications path between the print spooler and bidirectional printers that are capable of providing software-accessible status information.
They add printer control information, such as commands defined by a printer job language, to the data stream.” (see http://msdn.microsoft.com/en-us/library/ff556450(VS.85).aspx)

### Renderer Plug-In Modifications

### Current Architecture

Prior to sending each page of a document, a Page Info header structure is sent to the print spooler 204 indicating which page of the document is being sent as well as whether or not the page is simplex or duplex. This is a feature that was added to the print driver for the KODAK D4000 Duplex Photo Printer. This is later retrieved from the print spooler by the Language Monitor and is used to set up the printer appropriately. Interacting with software hooks provided by Microsoft to enable programmers to design custom plug-ins, the present Renderer Plug-In builds a print command and sends it to the print spooler. The Renderer Plug-In then applies the appropriate filters and image banding operations to the data created by the Renderer 202 and then spools out the rendered page (surface) data to the print spooler, three bytes (RGB) at a time, until the entire surface has been processed. The result of this process is that both the print command and a fully rendered, 8-bit RGB-interleaved page surface is transmitted to the print spooler as a rastered bit map. In parallel, the Language Monitor retrieves both the print command and associated image data and ultimately sends this to the bidirectional printer 206.

### Proposed Architecture

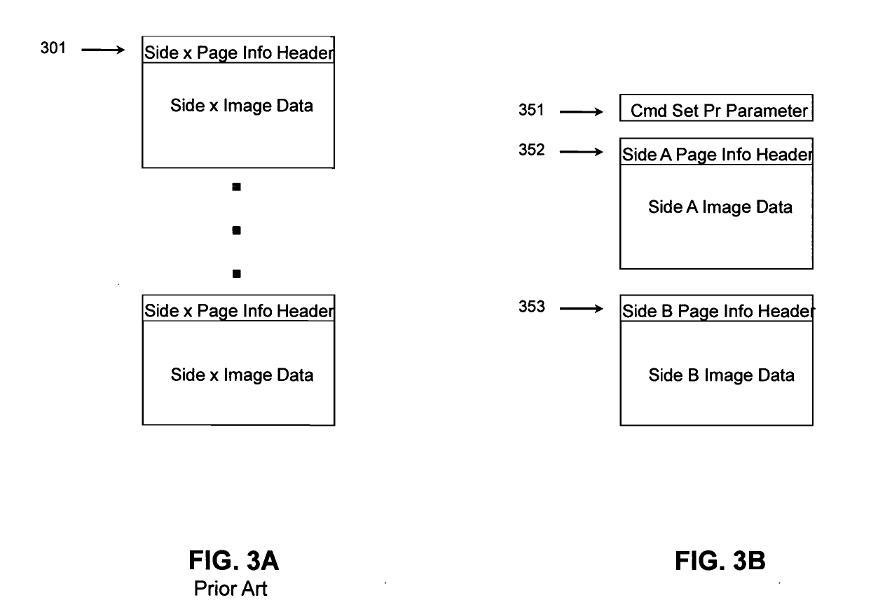

Rather than writing the entire rendered surface to the print spooler, a temporary file name will be constructed, and the rendered page surface data 103 will be written 102 to a temporary file 109, 209. The print command structure will be enhanced to include the name of the temporary file that was written. The result is that only the Page Info header and the enhanced command structure (see FIG. 3, 351, plus 352 and/or 353) will be sent from the renderer 202 through the spooler 204 and then read by the Language Monitor 208. The Language Monitor will be able to retrieve the image data in the temporary file using the temporary file full path name. No image data will be present in the print spooler files.

### Language Monitor Modifications

### Current Architecture

Now including reference to FIG. 3, the Language Monitor receives a Page Info header structure 301 from the spooler. On all Simplex pages and on Odd Duplex pages it constructs a Set Print Parameter Command and sends it to the Printer. Then, the Print Command and associated image data are retrieved from spooler and sent to the printer. The pages (surfaces) of the document are sent sequentially and the print spooler balances the process of rendering and printing.

### Proposed Architecture

When a Page Info header is received and ready to be processed 104, and the printer is in a quiescent state, the printer will be queried as to the location of the paper position with respect to one of two thermal print heads in the printer 105. At that point, the Language Monitor will possess the knowledge of which surface (side) of the following sheet is required to be sent first. The surface to be sent first corresponds to the print head at which the paper is positioned. This avoids unnecessary retraction and repositioning of the media sheet with respect to the print heads and also avoids compromising the media surface by additional rolling contact with the textured feed roller.

a. Simplex Sheet

If the Page Info header portion 351 indicates that the sheet is to be printed simplex, the Set Print Parameter Command will be built appropriately. This sets the parameter that signifies on which side the sheet should be printed. Since the back side of a simplex sheet is laminated automatically, only data for a single surface data needs to be sent. Then the Print Command and the enhanced print command structure will be read from the print spooler. The Language Monitor will read the surface data from the temporary cached file 109, 209 and transmit the Print Command followed by the surface data to the printer. Once the commands and image data have been successfully consumed by the printer, the

Language Monitor will delete the temporary file for that surface.

b. Duplex Sheet

If the Page Info header portion 351 indicates that the sheet is to be printed duplex, the Set Print Parameter Command will be built appropriately (based upon the heuristic that determines which thermal head will be used and which media side must be printed upon next). There are now two possible scenarios:

Scenario 1: The next surface required is the next logical page of the document. The next logical page of the document is the next lowest page number (after the current page number) of the document in its completed printed form, which logical page number sequence might not reflect the print sequence in which the pages were printed. In this case, the print command and the enhanced print command structure will be read from the spooler. The Language Monitor will read the surface data from the temporary cached file and transmit the Set Print Parameter Command followed by the Print Command followed by the surface data to the printer 106. Once the commands and image data have been successfully consumed by the Printer, the Language Monitor will delete the temporary file for the surface. Then this process repeats with the second surface of the Duplex sheet.

Scenario 2: The next surface required is the page after the next logical page of the document. We refer to the next logical page as the “first page” and the page after that as the “second page.” In this case, the print command and the enhanced print command structure will be read from the spooler. Then, the Language Monitor caches this enhanced print command information (as a function separate from the page surface image data) and waits until the next page (second page) print command is available to be read from the Spooler, i.e. after the Renderer finishes generating the second page image surface. Thus, image data for two surfaces are cached and the Language Monitor selects which is sent first to the printer. Then, the Set Print Parameter Command will be transmitted to the printer. The Language Monitor will read the second surface image data (second page) from the temporary file and then send the print command followed by the second surface image data to the printer 107. Then, the Language Monitor reads the temporary cached information (first page) and sends the print command followed by this first surface image data to the printer.

After the commands and image data have been successfully consumed by the printer, the Language Monitor will delete the temporary files for both surfaces of the duplex sheet.

### Error Detection and Recovery

With this caching scheme, there are five new error conditions that need to be accounted for:
1. Rendering Plug-In, the temporary filename cannot be constructed.
2. Rendering Plug-In, the temporary file cannot be written. In either of these cases, the print spooler needs to be informed that the Rendering failed. The user will observe this as a failure to print their jobs.
3. Language Monitor, in the case of duplex where the second surface of the sheet is required to be printed first, but is never received. After the first surface is received, a timer will be initiated that will be cleared when the second surface arrives. If the timer expires prior to receiving the second surface, and new error will be generated and sent to the print spooler.
4. Language Monitor, temporary files cannot be read. If the files cannot be opened or if their image data is corrupted or incomplete, a new error will be generated and sent to the print spooler.
5. User cancellation of jobs. In the current architecture, the print spooler removes all of the rendered surfaces that are no longer required. That is because the rendered data co-exists with the page meta data within the print spooler. In the proposed architecture, this is not the case. To eliminate these older cached temporary files, the Language Monitor will examine the time stamps of the active jobs and delete any outdated previously rendered files from the temporary directory.

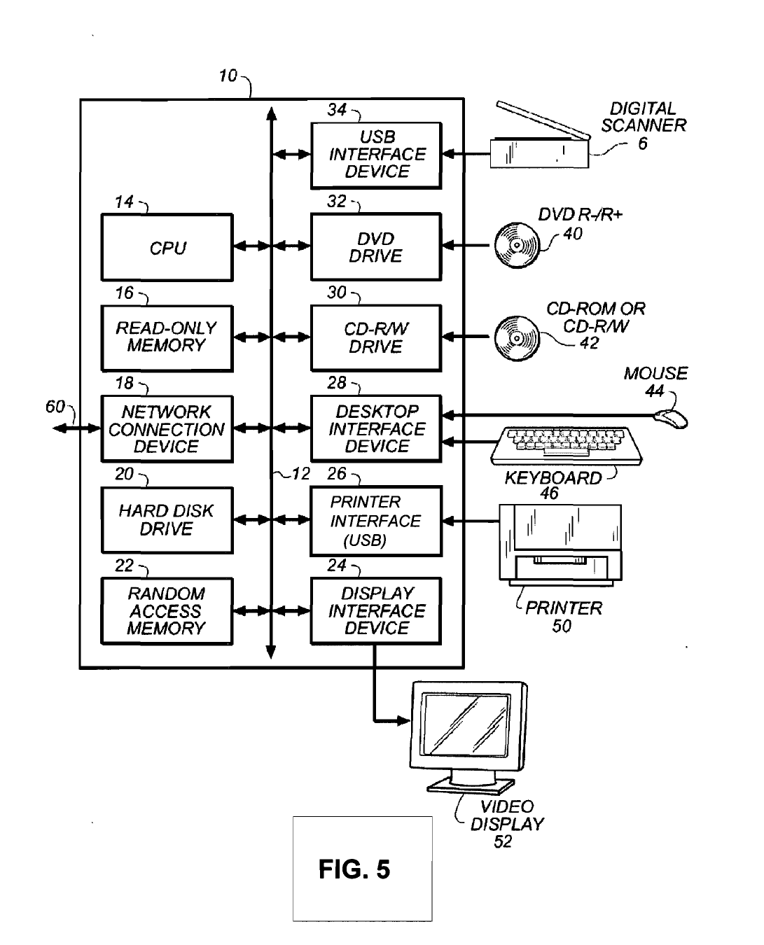

FIG. 5 illustrates an example printing system for practicing embodiments of the present invention. In this example embodiment, the printing system includes a host computer 10 which typically comprises input devices keyboard 46 and mouse 44 communicatively connected to the computer's desktop interface device 28. The interfaces illustrated in FIG. 5 can include USB interfaces and other wired connections, as well as wireless connections via Wi-Fi or cellular. The term “host computer” or “host PC” is intended to include any data processing device, such as a server, desktop computer, PC, a laptop computer, a mainframe computer, a router, a personal digital assistant, a Blackberry PDA, or any other computing device. The phrase “communicatively connected” is intended to include any type of connection or transmission media, whether wired, wireless, or both, between devices, computers, or programs in which data may be communicated.

Output from host computer 10 is typically presented on a video display 52, which may be communicatively connected to the computer 10 via the display interface device 24. Internally, the computer 10 contains components such as CPU 14 and computer-accessible memories, such as read-only memory 16, random access memory 22, and a hard disk drive 20, which may retain some or all of the image data, page surface data, cached page data, commands, print documents, character data, and programming referred to herein, including a language monitor, print spooler, plug-ins, renderers, and other rendering engines. The phrase “computer-accessible memory” is intended to include any computer-accessible data storage device, whether volatile or nonvolatile, electronic, magnetic, optical, or otherwise, including but not limited to, floppy disks, hard disks, Compact Discs, DVDs, flash memories, such as USB compliant flash drives, for example, and ROMs, and RAMs. The CPU 14 communicates with other devices over a data bus 12. The CPU 14 executes software stored on, for example, hard disk drive 20 as described above. In addition to fixed media such as a hard disk drive 20, the host computer 10 may also contain computer-accessible memory drives for reading and writing data, such as page print image data, from and to removable computer-accessible memories. This may include a CD-RW drive 30 for reading and writing various CD media 42 as well as a DVD drive 32 for reading and writing to various DVD media 40. The printer 50, such as described herein, is a dye diffusion thermal transfer printer bidirectionally connected to a printer interface device 26 for communicating with processor 14 over data bus 12. However, the printer 50 should not be considered as limited only to this type. Printer 50 can record images on a tangible surface using a variety of known technologies including, but not limited to, conventional four color offset separation printing, other contact printing such as silk screening can be performed, or dry electrophotography, other thermal printing technology, drop on demand ink jet technology, and continuous inkjet technology, or any combination of the above is represented as printer 50. The connection between the thermal printer 50 and the printer interface device 26 serves as a two way communication channel between the printer and the host computer. The printer 50 includes a supply of receiver media, typically in rolled form, and preferably includes an exit tray for holding a plurality of printed receiver media sheets. Printer 50 typically incorporates memory sufficient to store print data for a plurality of pages of a print job. Additional information can be stored for each type and size of media, including a finish of media, for example. The printer preferably includes selectable printing options such as duplex and simplex printing. These selectable options can be controlled by user input to the computer system via the mouse 44 or keyboard 46 illustrated, and as confirmed by a convenient graphical user interface on video display 52. A digital scanner 6 or other image capture device such as a digitizing tablet or a camera can be communicatively connected to the computer 10 through, for example, the USB interface device 34 to transfer image from the scanner 6 to the computer's hard disk drive or other connected memory devices. Finally, the computer 10 can be communicatively connected to an external network 60 via a network connection device 18, thus allowing the computer to access digital objects and media assets from other computers, devices, or data-storage systems communicatively connected to the network.

A collection of print documents, and/or media assets can reside exclusively on the hard disk drive 20, compact disc 42, DVD 40, or on remote data storage devices, such as a networked hard drive accessible via the network 60, or on other local memory devices such as a thumb drive. A collection of digital objects and documents can also be distributed across any or all of these storage locations. A collection of digital objects and documents may be represented by a database that uniquely identifies individual digital objects (e.g., such as a print job) and their corresponding location(s).

The invention has been described in detail with particular reference to certain preferred embodiments thereof, but it will be understood that variations and modifications can be effected within the spirit and scope of the invention.

### PARTS LIST

6 Scanner
10 Host
12 Bus
14 CPU
16 Memory
18 Connection Device
20 HDD
22 RAM
24 Interface
26 Interface
28 Interface
30 CD Drive
32 DVD Drive
34 Interface
40 DVD
42 CD
44 Mouse
46 Keyboard
50 Printer
52 Display
60 Network
101 Renderer Plug-In
102 Step
103 Step
104 Step
105 Step
106 Step
107 Step
108 Language Monitor
109 Temporary Cached File
200 Universal Printer Driver architecture
201 Renderer Plug-In
202 Renderer
203 User Interface Plug-In
204 Print Spooler
206 Printer
208 Language Monitor
209 Temporary Cached File
301 Page Header
351 Command Set Header
352 Page Header
353 Page Header

1. A printing system comprising:
a bidirectional printer having a pair of printheads for printing on opposite sides of a receiver media; and
a host computer connected to the printer for controlling a page printing sequence in the printer, the host computer comprising a renderer for generating first page surface data to be printed on one side of a receiver media in the printer, and a language monitor for determining that second page surface data is to be printed on the receiver media before the first page surface data, the language monitor comprising programming for delaying sending a print command to the printer until the second page surface data is rendered, whereafter the language monitor sends a print command to the printer with the second page surface data before sending the first page surface data to the printer.

2. The printing system of claim 1 wherein wherein the language monitor comprises programming for receiving information identifying a position of the receiver media in the printer and, in response to the information, determining that the second page surface data is to be printed on the receiver media before the first page surface data.

3. The printing system of claim 1, further comprising storage for temporarily storing the first page surface data while the second page surface data is rendered.

4. The printing system of claim 1 wherein the first page surface data and the second page surface data comprise a portion of a print job and the print job comprises a plurality of even numbered pages and a plurality of odd numbered pages, and wherein the language monitor is configured to print pairs of the even numbered pages consecutively during the print job and pairs of the odd numbered pages consecutively during the print job.

5. The printing system of claim 4 wherein the print job is a duplex print job.

6. The printing system of claim 4, wherein all of the plurality of the even numbered pages are printed on one of the printheads and all of the plurality of the odd numbered pages are printed on another one of the printheads.

7. A printing system comprising:
a renderer configured for generating print image data for a first logical page of a duplex print job;
a language monitor configured for receiving information from a connected printer identifying a position of a receiver media in the printer with respect to one of two printheads in the printer, and in response thereto, for determining that a second logical page of the print job is to be printed next in the printer before printing the first logical page of the print job, for temporarily storing the first logical page of the print job while print image data for the second logical page of the print job is being generated, and for sending the second logical page of the print job to the printer before sending the first logical page of the print job to the printer.

8. The system of claim 7 wherein the language monitor is configured for querying the printer to identify the position of the receiver media in the printer.

9. The system of claim 7 wherein the first logical page of the print job and the second logical page of the print job comprise a portion of the print job, the print job comprises a plurality of even numbered pages and a plurality of odd numbered pages, the language monitor is further configured to print pairs of the even numbered pages consecutively during the print job and pairs of the odd numbered pages consecutively during the print job, and wherein each of the odd numbered pages is printed by only one of the printheads on an opposite side of the receiver media from an even numbered page of the print job.

10. The system of claim 7, wherein the system temporarily stores the first logical page of the print job on a hard disk of the system.

11. A printing system comprising:
a printer;
a host computer connected to the printer for sending print commands and first page data to the printer, the host computer comprising a renderer for generating the first page data, and for temporarily storing the first page data in system storage, and a language monitor configured to selectively either send the print commands and the first page data to the printer or to retain the first page data in the system storage until the renderer completes generating second page data.

12. The printing system of claim 11, wherein the printer comprises a pair of printheads and a receiver media positioned at either of the printheads, the host computer further comprises means for receiving printer status data from the printer indicating a position of the receiver media in the printer, and wherein the language monitor is further configured to selectively either send the print commands and the first page data to the printer or to retain the first page data in the system storage until the renderer completes generating second page data based on the printer status data.

13. The printing system of claim 12, wherein, based on the printer status data, the language monitor retains the first page data in the system storage while the renderer completes generating second page data.

14. The printing system of claim 13, wherein the language monitor is further configured to send the second page data to the printer for printing on one side of the receiver media followed by sending the first page data to the printer for printing on an opposite side of the receiver media.

15. The printing system of claim 14, wherein the first page data is printed using one of the printheads and the second page data is printed using another one of the printheads.

16. A printing system comprising:
a renderer for generating image data for a logical first page of a print job and for generating a logical second page of the print job;
storage for storing the image data for the logical first page of the print job and for storing the logical second page of the print job;
means for receiving status data from a printer indicating a position of a receiver media in the printer with respect to one of two printheads in the printer; and
a language monitor for starting the print job in duplex format, the language monitor configured to send to the printer the logical second page of the print job before sending the logical first page of the print job, wherein the image data for the logical first page and the image data for the logical second page are each accessible by the language monitor to be sent first for printing on the printer.

17. The system of claim 16, wherein the status data indicates which one of the two printheads is capable of printing on the receiver media without retracting the receiver media.

18. The system of claim 16, further comprising means for requesting the status data from the printer.
